(19) United States
(12) Patent Application Publication
(10) Pub. No.: US 2026/0023425 A1
(43) Pub. Date: Jan. 22, 2026

(54) Configurable and Scalable Power Gating and Voltage Regulation

(71) Applicant: Advanced Micro Devices, Inc., Santa Clara, CA (US)

(72) Inventor: Peter T. Hardman, Austin, TX (US)

(73) Assignee: Advanced Micro Devices, Inc., Santa Clara, CA (US)

(21) Appl. No.: 18/774,797

(22) Filed: Jul. 16, 2024

(51) Int. Cl. G06F 1/3287; G06F 9/448

(52) U.S. Cl. CPC G06F 1/3287; G06F 9/4498

(57) ABSTRACT

In accordance with the described techniques, a device or system includes a digital logic circuit organized into multiple partitions, and a power gating circuit. Further, the digital logic circuit includes base logic representing the digital logic circuit before being modified by external logic of the system that is external to the digital logic circuit. The power gating circuit is configured to independently control power supplied to the multiple partitions of the digital logic circuit. As part of this, the power gating circuit initiates a power state transition to a power state in which an entirety of the base logic of the digital logic circuit is powered off.

### BACKGROUND

Power gating is a power management technique used in integrated circuits to reduce power consumption by selectively turning off power to inactive blocks of an integrated circuit. By doing so, power gating techniques minimize leakage power, which is power consumed by transistors of an integrated circuit which are in an inactive or idle state, but still consume power. Power gating is particularly effective in extending battery life for portable devices and reducing overall power usage in high-performance computing systems.

### BRIEF DESCRIPTION OF THE DRAWINGS

FIG. 1 is a block diagram of a non-limiting example system to implement configurable and scalable power gating and voltage regulation.

FIGS. 2a, 2b, and 2c depict a non-limiting example system depicting power state transitions in accordance with the described techniques.

FIG. 3 depicts a procedure in an example implementation of configurable and scalable power gating and voltage regulation.

FIG. 4 is a block diagram of a processing system configured to execute one or more applications, in accordance with one or more implementations.

### DETAILED DESCRIPTION

### Overview

A device (e.g., a laptop computer) includes a power gating circuit and a digital logic circuit. Broadly, the digital logic circuit is any hardware digital circuit within the device that performs specific functions within the device, including but not limited to processors, controllers, memories, and interfaces. The digital logic circuit is organized into multiple partitions, and the multiple partitions are allocated hardware resources (e.g., processing resources and memory resources) of the digital logic circuit. The multiple partitions include one or more process partitions that are assigned to performing processes and/or applications of the digital logic circuit, and a critical partition including critical-on circuitry that is to be powered up to support execution of the processes and/or applications assigned to the one or more process partitions. Broadly, the power gating circuit is configured to independently enable and disable power gating to the partitions, e.g., control whether power is supplied to the partitions.

Conventional power gating techniques typically have the critical-on circuitry connected to power at all times when the device is powered up, e.g., the critical-on circuitry is within the always-on power supply domain. Due to this, conventionally-configured electronic circuits consume power (e.g., exhibit power leakage) even when the integrated circuit is completely inactive and/or idle. Moreover, conventional power gating techniques simply gate power (on or off) to electronic circuits (or portions thereof), without controlling the voltage supplied thereto. Due to a lack of supply voltage control, conventionally-configured electronic circuits consume excess power in active states, e.g., in scenarios in which a reduced output voltage would be sufficient for a current state of an electronic circuit or an electronic circuit portion.

Thus, techniques for configurable and scalable power gating and voltage regulation are described herein to reduce power consumption of the digital logic circuit in both inactive and active states. In accordance with the described techniques, the power gating circuit initiates a power state transition for the digital logic circuit to a process-on state in which the critical partition and at least one process partition are powered on, e.g., to enable execution of one or more processes and/or applications assigned to the at least one process partition. While in the process-on state, the power gating circuit independently disables power gating to (e.g., powers up) process partitions when corresponding processes and/or applications are to be executed on the digital logic circuit. Also while in the process-on state, the power gating circuit independently enables power gating to (e.g., powers down) process partitions when corresponding processes and/or applications finish executing on the digital logic circuit.

The power gating circuit includes voltage regulation circuitry which adjusts the output voltage supplied to the process partitions. In particular, the voltage regulation circuitry enables different output voltages to be supplied to different partitions concurrently, and also enables different output voltages to be supplied to a single partition at different times.

To power on respective partitions, the power gating circuit issues control signals to the digital logic circuit which disable power gating to the respective partitions, e.g., cause the respective partitions to power up. The control signals include six or more bits (e.g., fourteen bits in one or more examples) having programmed thereon a power up sequence for a partition through a plurality of wake states having different wake values (e.g., values of electrical current) to be supplied to a partition when the partition is powered up. Furthermore, the control signals have programmed thereon delays between successive wake states, and the delays represent an amount of time (e.g., a number of clock signals) to wait until transitioning to a next successive wake state.

In various scenarios, the power gating circuit initiates a transition for the digital logic circuit to a base logic off state. Notably, the digital logic circuit includes base logic representing the digital logic circuit before being modified by external logic of the device that is external to the digital logic circuit. In the base logic off state, an entirety of the base logic is power gated, including the critical-on circuitry.

Thus, in contrast to conventional techniques, the described techniques power gate an entirety of the base logic of the digital logic circuit including the critical-on circuitry. The described techniques thus offer reduced power consumption for the device as compared to conventional techniques in scenarios in which the digital logic circuit is inactive or idle. In addition, the described techniques reduce power consumption in comparison to conventional power gating techniques when the digital logic circuit is active. This is because, unlike conventional techniques, the described techniques include voltage regulation support to supply reduced output voltages to one or more powered up partitions. The described techniques further offer increased customizability when programming power up sequences of the partitions by way of including six or more bits of control in the control signals, as opposed to just two bits of control for conventional power gating techniques. By doing so, the described techniques reduce instances of sudden current changes within the digital logic circuit and damage to the digital logic circuit resulting therefrom.

In some aspects, the techniques described herein relate to a system comprising a digital logic circuit organized into multiple partitions, the digital logic circuit including base logic representing the digital logic circuit before being modified by external logic of the system that is external to the digital logic circuit, and a power gating circuit to independently control power supplied to the multiple partitions of the digital logic circuit, and to initiate a power state transition for the digital logic circuit to a power state in which an entirety of the base logic of the digital logic circuit is powered off.

In some aspects, the techniques described herein relate to a system, wherein the multiple partitions each include one or more circuitry subsystems, and the power gating circuit is configured to insert, into each circuitry subsystem of the multiple partitions, power gating logic enabling the power gating circuit to power on or off the circuitry subsystems.

In some aspects, the techniques described herein relate to a system, wherein to independently control the power supplied to the multiple partitions, the power gating circuit is configured to issue control signals to the power gating logic of one or more partitions, the control signals causing the one or more circuitry subsystems of the one or more partitions to power on or off.

In some aspects, the techniques described herein relate to a system, wherein the control signals to power on the one or more partitions include six or more bits having programmed thereon a power up sequence of the one or more partitions through multiple wake states having different wake values and delays between successive wake states.

In some aspects, the techniques described herein relate to a system, wherein the control signals are delivered to the power gating logic of multiple circuitry subsystems of the one or more partitions via repeater circuits which cause arrival of the control signals at the power gating logic of the multiple circuitry subsystems concurrently.

In some aspects, the techniques described herein relate to a system, wherein the power gating circuit includes multiple finite state machines assigned to corresponding partitions of the multiple partitions, and the power gating circuit is configured to receive a request to power on an individual partition of the multiple partitions, and issue, by a finite state machine assigned to the individual partition, the control signals to the power gating logic of the individual partition in response to receipt of the request.

In some aspects, the techniques described herein relate to a system, wherein the multiple partitions include at least one partition assigned to executing processes of the digital logic circuit, and at least one finite state machine assigned to the at least one partition is powered off when the at least one partition is powered off.

In some aspects, the techniques described herein relate to a system, wherein to independently control the power supplied to the multiple partitions, the power gating circuit is configured to independently control amounts of voltage supplied to the multiple partitions of the digital logic circuit, the amounts of voltage concurrently supplied to at least two partitions of the multiple partitions being different.

In some aspects, the techniques described herein relate to a system, wherein the multiple partitions include one or more partitions assigned to executing processes of the digital logic circuit and a critical partition including critical-on circuitry that is to be powered on to support execution of the processes, and the power gating circuit is configured to initiate, during an initial boot sequence for the digital logic circuit, a first power state transition for the digital logic circuit to a first additional power state in which the multiple partitions are powered on, and initiate, responsive to a memory repair protocol having been completed by the digital logic circuit while in the first additional power state, a second power state transition for the digital logic circuit from the first additional power state to a second additional power state in which the critical partition is powered on and the one or more partitions are powered off.

In some aspects, the techniques described herein relate to a system, wherein the power gating circuit is configured to initiate a third power state transition from the second additional power state to a third additional power state in which the critical partition is powered on and at least one partition of the one or more partitions is powered on to enable execution of one or more processes of the digital logic circuit assigned to be executed by the at least one partition.

In some aspects, the techniques described herein relate to a system, wherein the power gating circuit is configured to initiate the power state transition from the second additional power state to the power state in response to a state of data within the digital logic circuit being saved to a non-volatile memory of the digital logic circuit or an external memory source that is powered on while the digital logic circuit is in the power state, and initiate a fourth power state transition from the power state to the second additional power state, the fourth power state transition involving the state of data within the digital logic circuit being restored to a volatile memory source within the critical partition of the digital logic circuit.

In some aspects, the techniques described herein relate to a system, wherein the power gating circuit is clock gated when the digital logic circuit is in the power state.

In some aspects, the techniques described herein relate to a device, comprising a digital logic circuit organized into multiple partitions, and a power gating circuit to independently control amounts of voltage supplied to the multiple partitions of the digital logic circuit, the voltage concurrently supplied to two or more partitions of the multiple partitions being different.

In some aspects, the techniques described herein relate to a device, wherein the voltage supplied to an individual partition of the multiple partitions is different at different times.

In some aspects, the techniques described herein relate to a device, wherein the voltage supplied to an individual partition of the multiple partitions is different at different times.

In some aspects, the techniques described herein relate to a device, wherein the voltage supplied to an individual partition of the multiple partitions is different at different times.

In some aspects, the techniques described herein relate to a device, wherein the digital logic circuit includes base logic representing the digital logic circuit before being modified by external logic of the device that is external to the digital logic circuit, and the power gating circuit is configured to initiate a power state transition for the digital logic circuit to a power state in which an entirety of the base logic of the digital logic circuit is powered off.

In some aspects, the techniques described herein relate to a method comprising receiving, by a power gating circuit, a request to power on one or more partitions of multiple partitions of a digital logic circuit, and issuing, by the power gating circuit, control signals to power on the one or more partitions, the control signals including six or more bits having programmed thereon a power up sequence of the one or more partitions through multiple wake states having different wake values and delays between successive wake states.

In some aspects, the techniques described herein relate to a method, further comprising independently controlling, by the power gating circuit, amounts of voltage supplied to the multiple partitions of the digital logic circuit, the amounts of voltage concurrently supplied to two or more partitions of the multiple partitions being different.

In some aspects, the techniques described herein relate to a method, wherein the digital logic circuit and the power gating circuit are integrated in a system-on-a-chip, and the digital logic circuit includes base logic representing the digital logic circuit before being modified by external logic of the system-on-a-chip that is external to the digital logic circuit, the method further comprising initiating, by the power gating circuit, a power state transition for the digital logic circuit to a power state in which an entirety of the base logic of the digital logic circuit is powered off.

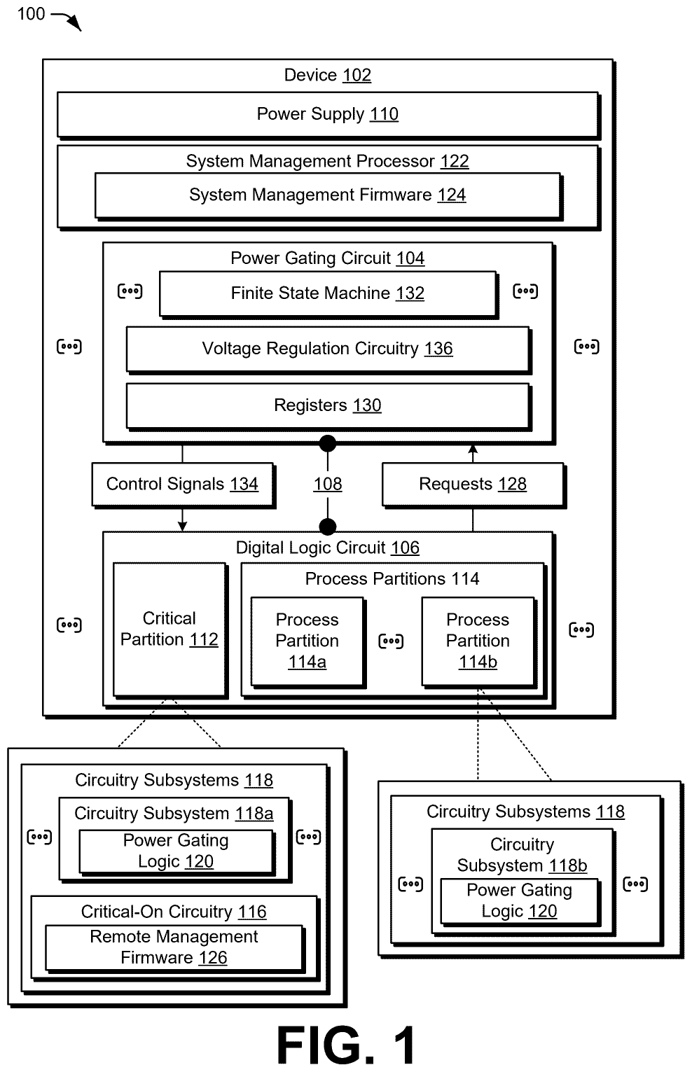

FIG. 1 is a block diagram of a non-limiting example system 100 to implement configurable and scalable power gating. The system 100 includes a device 102 having a power gating circuit 104 and a digital logic circuit 106 interconnected via one or more communication links 108. The communication links 108 include wired and/or wireless connections. Example wired connections include, but are not limited to, buses (e.g., a data bus), interconnects, traces, and planes. In at least one example, the communication links 108 include one or more sideband networks enabling direct communication between the digital logic circuit 106 and the power gating circuit 104. Examples of the device 102 include, but are not limited to, supercomputers and/or computer clusters of high-performance computing (HPC) environments, servers, personal computers, laptops, desktops, game consoles, set top boxes, tablets, smartphones, mobile devices, virtual and/or augmented reality devices, wearables, medical devices, systems on chips, and other computing devices or systems.

Broadly, the power gating circuit 104 is a controller that controls power and/or voltage supplied to the digital logic circuit 106. By way of example, the device 102 includes a power supply 110 (e.g., supplied by a power source, such as a battery of the device 102) that provides power to hardware elements (e.g., digital circuits) of the device 102. In various examples, the power gating circuit 104 controls whether partitions of the digital logic circuit 106 receive the power supply 110. For instance, the power gating circuit 104 powers down partitions of the digital logic circuit 106 that are not in active use. This notion of powering down circuits and/or portions of circuits within the device 102 that are not in active use is referred to as power gating. As further discussed below, the power gating circuit 104 additionally controls output voltages provided to the digital logic circuit 106 and/or partitions thereof, in one or more implementations.

In general, the digital logic circuit 106 is any hardware digital circuit within the device 102 that performs specific functions within the device 102, including but not limited to processors, controllers, memories, and interfaces. In various examples, the digital logic circuit 106 includes or corresponds to a central processing unit (CPU), a graphics processing unit (GPUs), an image signal processor (ISP), a digital signal processor (DSP), a neural processing unit (NPU), an inference processor, a display controller, a video encoder, a universal serial bus (USB) controller, dynamic random-access memory (DRAM), static random-access memory (SRAM), non-volatile memory, an input/output (I/O) interface, a peripheral component interconnect express (PCIe) interface, and so on.

Although one power gating circuit 104 is illustrated as controlling the power supply 110 to one digital logic circuit 106, this example is not to be construed as limiting. Rather, as shown by the illustrated ellipses, the device 102 includes any number of power gating circuits 104 and any number of digital logic circuits 106 in variations. In at least one example, each power gating circuit 104 controls the power and voltage supplied to one corresponding digital logic circuit 106. In another example, one or more power gating circuits 104 control the power and voltage supplied to multiple digital logic circuits 106.

As shown, the digital logic circuit 106 includes multiple partitions, and the power gating circuit 104 is configured to independently control the power supplied to the multiple partitions. Further, the multiple partitions include a critical partition 112 and one or more process partitions 114, e.g., process partition 114a and process partition 114b. Broadly, the one or more process partitions 114 are each assigned to executing one or more processes and/or applications of the digital logic circuit 106, and the critical partition includes 112 includes critical-on circuitry 116 which is to be powered on to enable execution of the processes and/or applications on the digital logic circuit 106. In an example in which the digital logic circuit 106 is an image signal processor, for instance, the processes and/or applications assigned to the different process partitions are different image signal processing tasks.

In accordance with the described techniques, each of the partitions (e.g., the critical partition 112 and each of the process partitions 114) include one or more circuitry subsystems 118. As shown, for instance, the critical partition 112 includes one or more circuitry subsystems 118a and the process partitions 114 each include one or more circuitry subsystems 118b. Broadly, the circuitry subsystems 118 are modular units (e.g., tiles) that make up the architecture of the digital logic circuit 106. Each circuitry subsystem 118 includes, by way of example and not limitation, one or more processors and/or processor cores, one or more local memory systems, and/or one or more communication links and/or interfaces to communicate with external hardware elements (e.g., digital circuits) of the device 102 and/or other circuitry subsystems 118 within the digital logic circuit 106. In one or more examples, there are different numbers of circuitry subsystems 118 in different partitions 112, 114 of the digital logic circuit 106. In at least one example, a single circuitry subsystem 118 is mapped to just one partition 112, 114 of the digital logic circuit 106. Additionally or alternatively, a single circuitry subsystems 118 is mapped to multiple partitions 112, 114 of the digital logic circuit 106, e.g., multiple partitions 112, 114 exist within a single circuitry subsystem 118.

Although the power gating circuit 104 is illustrated as a separate circuit that is separate from the digital logic circuit 106, this example is not to be construed as limiting. Rather, the power gating circuit 104 is a component of the digital logic circuit 106 in various implementations. For instance, the power gating circuit 104 is implemented within a circuitry subsystem 118 of the digital logic circuit 106.

In accordance with the described techniques, the power gating circuit 104 inserts power gating logic 120 into each circuitry subsystem 118 of the digital logic circuit 106. In various examples, the power gating logic 120 inserted into each circuitry subsystem 118 includes one or more power gating headers (e.g., transistors) that are controllable by the power gating circuit 104 (e.g., to disable and enable power gating) via transmission of control signals. Notably, the power gating logic 120 in each circuitry subsystem 118 operates within an always-on power domain, e.g., the power gating logic 120 is powered on at all times when the device 102 is powered on. This enables the power gating circuit 104 to disable power gating to partitions 112, 114 when the partitions 112, 114 are power gated.

The device 102 additionally includes a system management processor 122 which is a digital circuit that runs system management firmware 124. The system management processor 122 and the system management firmware 124 perform various power management tasks, such as coordinating power state transitions and initiating boot sequences for the device 102, e.g., ensuring that hardware elements (e.g., digital circuits) within the device 102 and/or system-on-a-chip are powered on and initialized correctly. Although not shown, the device 102 includes a system management network (SMN) that provides communication links and/or pathways facilitating communication between the system management processor 122 and other hardware elements of the device 102, e.g., the power gating circuit 104 and the digital logic circuit 106. Furthermore, remote management firmware 126 is illustrated as running on the critical-on circuitry 116. The remote management firmware 126 is representative of functionality for performing various power management tasks with respect to the digital logic circuit 106, specifically.

In one or more implementations, requests 128 are sent to the power gating circuit 104 requesting to power on or off respective partitions 112, 114 of the digital logic circuit 106. In one or more implementations, the requests 128 are sent by a dedicated hardware unit (e.g., a remote system management unit (RSMU)) within the critical-on circuitry 116 of the critical partition 112 via the communication link 108, e.g., the dedicated sideband network and/or interface. Additionally or alternatively, the requests 128 are sent by the remote management firmware 126 or the system management firmware 124 via the system management network. The requests 128 received via the system management network are effective to program hardware registers 130 within the power gating circuit 104 allocated to respective partitions 112, 114, such that the programmed registers 130 indicate which partitions 112, 114 are to be powered on and which partitions 112, 114 are to be powered off.

As further discussed below, the described techniques support a power state in which each of the partitions 112, 114 (including the critical-on circuitry 116) are powered down and the inserted power gating logic 120 is the only portion of the digital logic circuit 106 that is powered up. Transitions out of this power state are requested by the system management firmware 124, e.g., because the critical-on circuitry 116 including the RSMU and the remote management firmware 126 are power gated. Contrarily, in situations in which at least the critical partition 112 is powered on, power state transitions are requested by the remote management firmware 126 or RSMU of the critical-on circuitry 116.

Regardless of how the requests 128 are received, the requests 128 indicate to the power gating circuit 104 which partitions 112, 114 are to be powered on and which partitions 112, 114 are to be powered off. To facilitate powering on or off respective partitions 112, 114, the power gating circuit 104 includes one or more finite state machines 132. Broadly, the finite state machines 132 are digital circuits configured to issue control signals 134 to power on or off respective partitions 112, 114. In one or more examples, one finite state machine 132 is assigned to each partition 112, 114, and the one finite state machine 132 issues control signals 134 that enable and disable power gating to the circuitry subsystems 118 within the assigned partition 112, 114. By way of example, a finite state machine 132 issues control signals 134 to the power gating logic 120 of the partition 112, 114 assigned to the finite state machine 132, and the control signals 134 cause the circuitry subsystems 118 within the partition 112, 114 to power on or off.

In one or more examples, the control signals 134 include six or more programmable bits controlling a power up sequence of a partition 112, 114 through multiple wake states having different wake values and delays between successive wake states. For example, the six or more bits are programmable (e.g., by a programmer or developer) to specify a plurality of wake states having different wake values (e.g., values of electrical current) to be supplied during a ramp-up period when a partition 112, 114 is transitioning from a power gated state to a non-power-gated state. Furthermore, the six or more bits are programmable (e.g., by a programmer or developer) to specify delay values between successive wake states that represent an amount of time (e.g., a number of clock cycles) to wait before transitioning from a previous wake state to a next successive state. In an example, control signals 134 sent to a partition 112, 114 are programmed with a first wake state having a first wake value, a next successive wake state having a second wake value (e.g., that is higher than the first wake value), and a wake delay of ninety-five clock cycles between the wake states. In this example, the control signals 134 cause the circuitry subsystems 118 to power up to the first wake value, and wait ninety-five clock cycles before powering up to the second wake value.

In one or more examples, the control signals 134 are delivered to the circuitry subsystems 118 via repeater circuits, which are configured to regenerate and amplify the control signals 134 to ensure that the control signals 134 can travel longer distances without degradation. In particular, the repeater circuits cause the control signals 134 to be delivered to the power gating logic 120 of different circuitry subsystems 118 concurrently, and with the same signal strength as originally output by the finite state machines 132.

Furthermore, the power gating circuit 104 includes voltage regulation circuitry 136 (e.g., a low dropout voltage regulator), which is representative of functionality for independently regulating amounts of voltage supplied to the partitions 112, 114 of the digital logic circuit 106. As part of this, the device 102 receives an input voltage, e.g., a voltage value provided by the power source of the device 102. The voltage regulation circuitry 136 includes one or more transistors (e.g., the power gating headers of the power gating logic 120) which control the flow of current from the power source to the partitions 112, 114. In various implementations, the voltage regulation circuitry 136 is configured to provide a regulated output voltage to one or more of the partitions 112, 114. To do so, the voltage regulation circuitry 136 modulates the resistance of the transistors, which adjusts (e.g. reduces) the output voltage supplied to the partitions 112, 114.

Additionally or alternatively, the power gating circuit 104 is configured to supply a bypass voltage to one or more of the partitions 112, 114. To do so, the voltage regulation circuitry 136 passes the input voltage directly to the one or more partitions 112, 114 without adjusting the resistance of the one or more transistors, e.g., the one or more partitions 112, 114 receive the full input voltage. In various implementation scenarios, one or more partitions 112, 114 receive the regulated output voltage, concurrently while one or more partitions 112, 114 receive the bypass voltage, concurrently while one or more partitions 112, 114 are power gated.

In one or more implementations, the digital logic circuit 106 includes one or more power supply monitors (PSMs) (e.g., implemented at least partially in circuitry of the digital logic circuit 106) which monitor the output voltage within the digital logic circuit 106. In some examples, the one or more PSMs are included as part of the power gating logic 120 of one or more of the partitions 112, 114. The one or more PSMs constantly monitor the output voltage within the digital logic circuit 106, and provide an indication of the constantly monitored output voltage to the voltage regulation circuitry 136. The voltage regulation circuitry 136 compares the constantly monitored output voltage against a reference voltage (e.g., a desired bypass voltage or a desired regulation voltage), and constantly adjusts the resistance of the one or more transistors to maintain a stable output voltage within the digital logic circuit 106 that coincides with the reference voltage. In variations, there is one PSM inserted into each partition 112, 114, or there is one PSM inserted into the digital logic circuit 106.

In one or more examples, the voltage regulation circuitry 136 is configured to receive a constant input voltage and supply a constant regulated output voltage to the partitions 112, 114. By supplying a constant regulation output voltage, the voltage regulation circuitry 136 conserves physical space within the device 102 and/or system-on-a-chip by removing physical elements (e.g., Gain Schedulers and Input Power Supply Monitors (PSMs)) that would otherwise be included as part of more complex voltage regulation schemes that support multiple and/or configurable regulated output voltages. Supplying a constant regulation output voltage also enables the described voltage regulation circuitry 136 to consume less power than such complex voltage regulation schemes.

In one or more implementations, the power gating circuit 104 initiates a power state transition to an ultra-low power state in which an entirety of the digital logic circuit 106 is powered down (e.g., including each of the partitions 112, 114), except for the inserted power gating logic 120. In other words, the digital logic circuit 106 includes base logic representing the digital logic circuit 106 before it is modified by external logic of the device 102 and/or system-on-a-chip that is external to the digital logic circuit 106. Since the only portion of the digital logic circuit 106 receiving power in this ultra-low power state is the power gating logic 120 inserted by the power gating circuit 104 (which is an example of external logic that exists on the device 102 externally from the digital logic circuit 106), an entirety of the base logic of the digital logic circuit 106 is powered off in this ultra-low power state.

In this ultra-low power state, even the critical-on circuitry 116 is powered off, e.g., the critical-on circuitry 116 includes but is not limited to including a remote system management unit, a communication interface of the system management network, local memory of the digital logic circuit, and so on. This contrasts with conventional power gating techniques which operate the critical-on circuitry 116 within an always-on power domain, e.g., the critical-on circuitry 116 is powered on at all times when the device 102 is powered on. Thus, the described techniques offer reduced power consumption when the digital logic circuit 106 by powering down the entirety of the base logic of the digital logic circuit 106 (e.g., including the critical-on circuitry 116) when the digital logic circuit 106 is idle and/or inactive.

Furthermore, in contrast to conventional techniques which offer two bits of control within power gating control signals, the described techniques offer six or more bits of control (e.g., fourteen bits of control in various examples) within the control signals 134. Thus, the described techniques offer increased customization (e.g., an increased number of wake states, and increased customizability of delay values) when powering up a partition 112, 114. This reduces instances of sudden current changes within the digital logic circuit 106, thereby also decreasing the risk of damage to the digital logic circuit 106 resulting therefrom. Further, unlike conventional power gating schemes, the described techniques implement the voltage regulation circuitry 136 to provide a regulated output voltage to one or more partitions 112, 114 in various scenarios. This reduces power consumption even in scenarios in which the digital logic circuit 106 is in active use. Lastly, in contrast to conventional techniques which offer limited partitions and limited functional blocks within partitions, the described techniques include any number of partitions 112, 114 and any number of circuitry subsystems 118 within the partitions 112, 114, thereby improving configurability and scalability of the power gating and voltage regulation scheme.

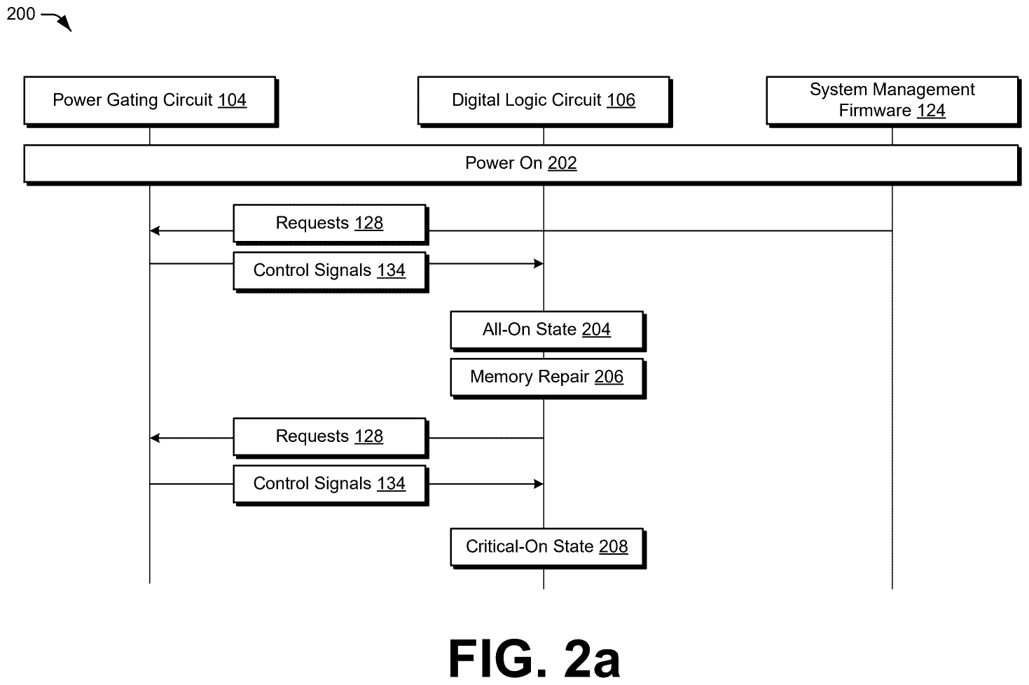

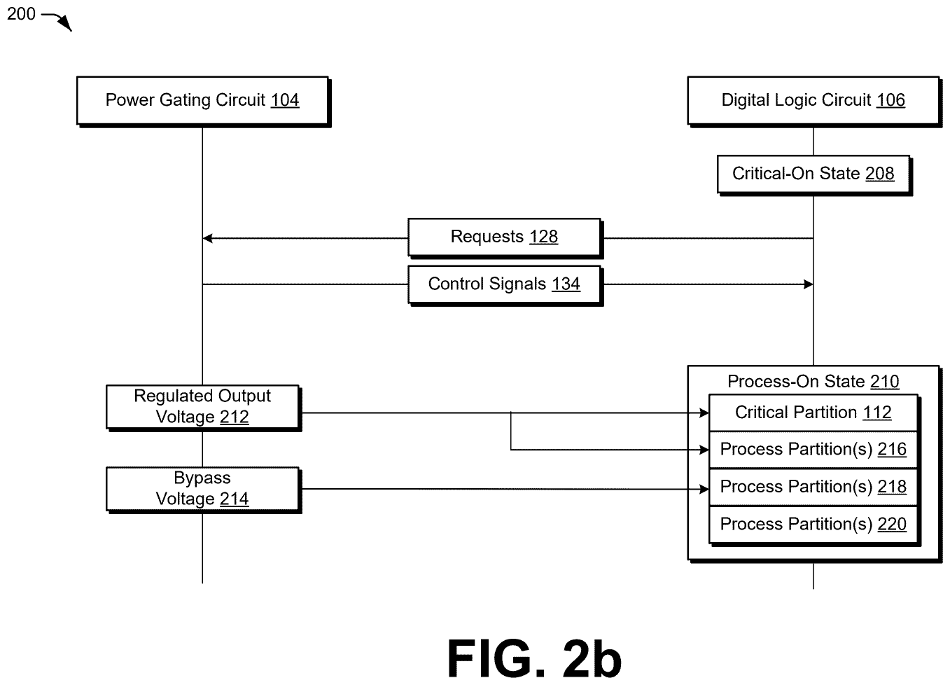

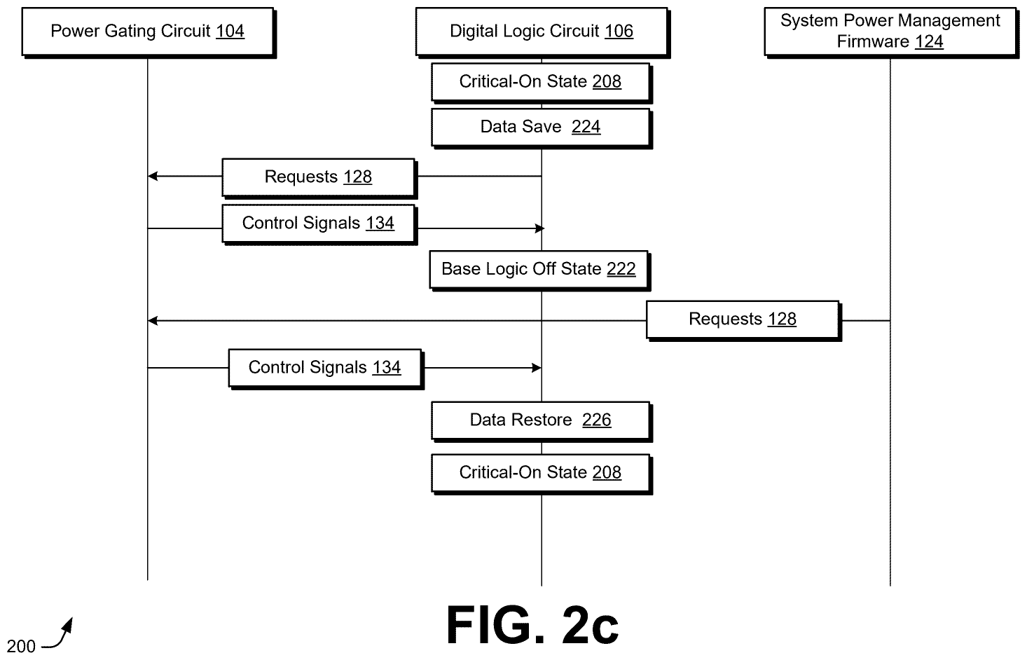

FIGS. 2a, 2b, 2c depict a non-limiting example 200 of power state transitions in accordance with the described techniques. In particular, FIG. 2a depicts power state transitions during an initial cold boot sequence to power up the digital logic circuit 106 when the device is powered on, as shown at 202. After the device 102 is powered on and while the digital logic circuit 106 is still powered off, the system management firmware 124 communicates requests 128 to the power gating circuit 104. Here, the requests 128 indicate to power on each of the partitions 112, 114. Accordingly, the power gating circuit 104 issues control signals 134, which cause the power gating logic 120 to power on (e.g., disable power gating to) the circuitry subsystems 118 within the partitions 112, 114. In other words, the digital logic circuit 106 transitions from being powered off (e.g., while the device 102 is powered off) to an all-on state 204 in which all of the partitions 112, 114 are powered on. In the all-on state 204, the power gating circuit 104 supplies the regulated output voltage or the bypass voltage to the partitions 112, 114.

Once operating in the all-on state 204, the digital logic circuit 106 initiates memory repair 206. Broadly, memory repair 206 is a protocol to identify and rectify defects or faults (e.g., stuck-at faults, bridging faults, and open faults) within memory cells of the digital logic circuit 106. In various examples, a memory repair 206 protocol includes and/or utilizes built-in self-test (BIST) mechanisms, error correction codes (ECC), redundancy allocation (e.g., replacing faulty cells, faulty rows, and/or faulty columns with redundant cells, rows, and/or columns), memory scrubbing, and the like. Once the memory repair 206 protocol has completed, the digital logic circuit 106 communicates requests 128 to the power gating circuit 104 indicating to power down the process partitions 114.

In response to the requests 128, the power gating circuit 104 issues control signals 134 which cause the power gating logic 120 to power off (e.g., enable power gating to) the circuitry subsystems 118 within the process partitions 114. In other words, the digital logic circuit 106 transitions from the all-on state 204 to a critical-on state 208 in which the critical partition 112 is powered on, and the process partitions 114 are powered off. In the critical-on state 208, the power gating circuit 104 supplies the regulated output voltage or the bypass voltage to the critical partition 112. From the critical-on state 208, the digital logic circuit 106 can request to transition to a process-on state in which at least one process partition 114 is powered on to run processes or applications associated with the at least one process partition 114, as further discussed below with reference to FIG. 2b. Additionally or alternatively, the digital logic circuit 106 can request to transition to the aforementioned ultra-low power state state in scenarios in which the digital logic circuit is sitting idle for at least a threshold duration, as further discussed below with reference to FIG. 2c.

FIG. 2b depicts a power state transition from the critical-on state 208 to a process-on state 210 in which at least one process partition 114 is powered on to run processes or applications associated with the at least one process partition 114. As shown, the digital logic circuit 106 is initially operating in the critical-on state 208. Here, the digital logic circuit 106 determines that one or more applications or processes are to be run and/or executed on the digital logic circuit 106. Accordingly, the digital logic circuit 106 sends requests 128 to the power gating circuit 104 requesting one or more process partitions 114 (that are mapped to the one or more applications or processes) to be powered on.

In response to the requests 128, the power gating circuit 104 issues control signals 134 which cause the power gating logic 120 to power on (e.g., disable power gating to) the circuitry subsystems 118 of the one or more process partitions 114. In other words, the digital logic circuit 106 transitions from the critical-on state 208 to a process-on state 210 in which the critical partition 112 and at least one process partition 114 are powered on. Although not depicted, the digital logic circuit 106 sends requests 128 and receives corresponding control signals 134 while in the process-on state 210 to power off process partitions 114 that are currently powered on, e.g., when applications and/or processes of the process partitions 114 finish executing. Furthermore, the digital logic circuit 106 sends requests 128 and receives corresponding control signals 134 while in the process-on state 210 to power on process partitions 114 that are currently powered off, e.g., when new applications and/or processes of the process partitions are to be executed on the digital logic circuit 106.

In the process-on state 210, the power gating circuit 104 supplies the regulated output voltage 212 to one or more partitions 112, 114, concurrently while the power gating circuit 104 supplies the bypass voltage 214 to one or more partitions 112, 114, concurrently while one or more process partitions are power gated. In the illustrated example, for instance, the critical partition 112 and one or more process partitions 216 are supplied the regulated output voltage 212, one or more process partitions 218 are supplied the bypass voltage 214, and one or more process partitions 220 are power gated.

FIG. 2c depicts power state transitions to enter and exit a base logic off state 222 in which the power supply 110 is disconnected from an entirety of the base logic of the digital logic circuit 106 (e.g., including the multiple partitions 112, 114 and the critical-on circuitry 116), and the only portion of the digital logic circuit 106 connected to the power supply 110 is the power gating logic 120 inserted into each circuitry subsystem 118. While in the critical-on state 208, the digital logic circuit 106 determines that the digital logic circuit 106 has been sitting idle (e.g., without powering up the process partitions 114 to execute any applications or processes) for at least a threshold duration. Accordingly, the digital logic circuit 106 initiates a data save 224 protocol, which saves a state of the data within the digital logic circuit 106 to either a non-volatile memory source within the critical partition 112 of the digital logic circuit 106 or an external memory source (e.g., within the device 102 but external to the digital logic circuit 106) that is connected to the power supply 110 while the digital logic circuit 106 operates in the base logic off state 222. Notably, the state of the data within the digital logic circuit 106 saved during the data save 224 protocol includes or corresponds to a configuration of the digital logic circuit 106, e.g., operational parameters, configuration settings, data temporarily stored within the digital logic circuit 106, and the like.

Once the data save 224 protocol completes, the digital logic circuit 106 communicates requests 128 to the power gating circuit 104 indicating to power down the partition 112. In response to the requests 128, the power gating circuit 104 issues control signals 134 which cause the power gating logic 120 to power off (e.g., enable power gating to) the circuitry subsystems 118 of the critical partition 112. In other words, the digital logic circuit 106 transitions from the critical-on state 208 to the base logic off state 222.

While the digital logic circuit 106 is in the base logic off state 222, the system management firmware 124 determines that the digital logic circuit 106 is about to be used by the device 102. Accordingly, the system management firmware 124 communicates requests 128 to the power gating circuit 104 indicating to power up the critical partition 112. In response to the requests 128, the power gating circuit 104 issues control signals 134 to the digital logic circuit 106, which cause the power gating logic 120 to power on (e.g., disable power gating to) the circuitry subsystems 118 within the critical partition 112. In other words, the digital logic circuit 106 transitions from the base logic off state 222 back to the critical-on state 208. While in the critical-on state 208, the digital logic circuit 106 can request to transition to the process-on state 210 or back to the base logic off state 222, as previously mentioned.

As part of transitioning from the base logic off state 222, the digital logic circuit 106 initiates a data restore 226 protocol, which restores a state of the data within the digital logic circuit 106 to a local volatile memory source (e.g., static random-access memory) within the critical-on circuitry 116. In particular, the digital logic circuit 106 retrieves the state of the data from the non-volatile memory source and/or the external memory source, and restores the data to the local volatile memory source. By implementing the data save 224 protocol and the data restore 226 protocol in the manner described, the described techniques preserve data integrity in digital logic circuit 106, which enables proper functioning of the digital logic circuit 106 with minimal latency transitioning in and out of the base logic off state 222. Notably, exiting the base logic off state 222 involves performing the data restore 226 protocol, but does not involve performing the memory repair 206 protocol. Rather, the memory repair 206 protocol is only performed during an initial boot sequence to power on the digital logic circuit 106 when the device 102 is powered on.

In certain implementation scenarios, the power gating circuit 104 is fully clock gated when the digital logic circuit 106 is in the base logic off state 222 and when the digital logic circuit 106 is powered off during the initial cold boot sequence, e.g., the power gating circuit 104 ceases to receive a clock signal. Furthermore, as previously discussed, the power gating circuit 104 includes one finite state machine 132 assigned to each partition 112, 114 in various implementations. In scenarios in which process partitions 114 are power gated (e.g., the base logic off state 222, the critical-on state 208, and the process-on state 210), the finite state machines 132 assigned to the power gated process partitions 114 are also power gated. By clock gating the digital logic circuit 106 in the base logic off state 222 and power gating finite state machines 132 assigned to power gated process partitions 114, the described techniques further reduce power consumption for the device 102.

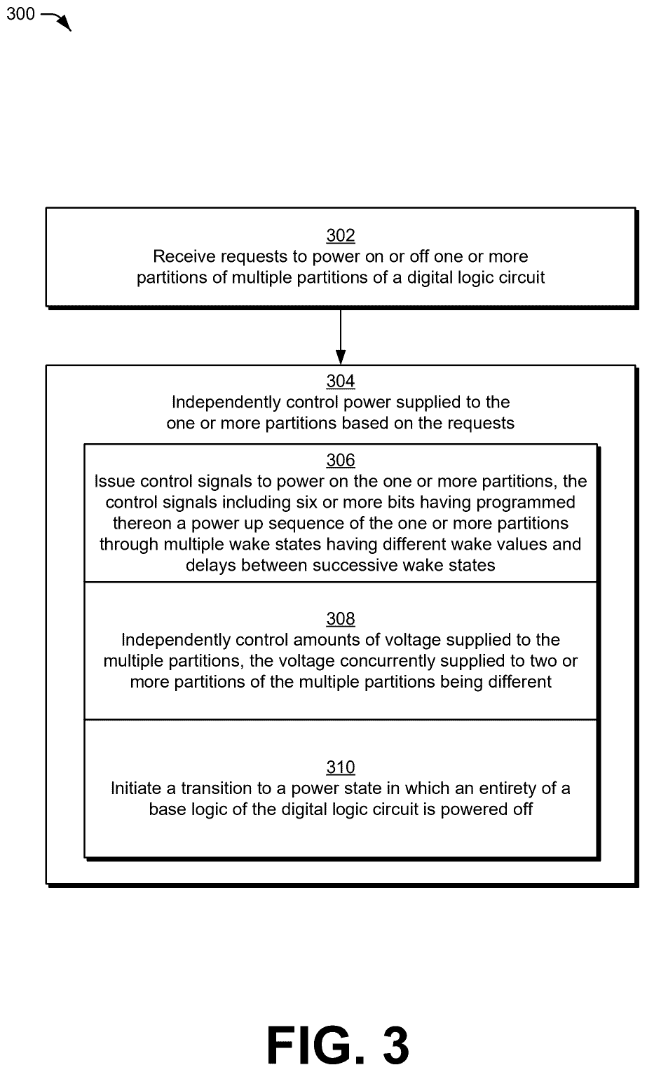

FIG. 3 depicts a procedure 300 in an example implementation of configurable and scalable power gating and voltage regulation. In the procedure 300, requests are received to power on or off one or more partitions of a digital logic circuit (block 302). By way of example, the digital logic circuit 106 is organized into a critical partition 112 and one or more process partitions 114. The process partitions 114 are mapped to processes and applications that are executable by the digital logic circuit 106, while the critical partition 112 includes critical-on circuitry 116 that is to be powered on in order to support execution of the processes and applications. Here, requests 128 are received from firmware (e.g., the remote management firmware 126) or hardware (e.g., a remote system management unit within the critical-on circuitry 116) of the digital logic circuit 106 or from the system management firmware 124. In various examples, the requests 128 instruct the power gating circuit 104 to control power gating logic 120 within the digital logic circuit 106 to enable and disable power gating to one or more of the partitions 112, 114.

Power supplied to the one or more partitions is controlled based on the requests (block 304). By way of example, the power gating circuit 104 controls the power gating logic 120 to power on or off one or more of the partitions 112, 114 requested to be powered on or off by the requests 128. In one example, the power gating circuit 104 initiates, as part of a cold boot sequence for the digital logic circuit 106, a first power state transition to an all-on state 204 in which all of the partitions 112, 114 are powered on, e.g., to enable a memory repair 206 protocol to be performed. In this example, the power gating circuit 104 initiates a second transition from the all-on state 204 to a critical-on state 208 in which the critical partition 112 is powered on, but the process partitions 114 are powered off. In another example, the power gating circuit 104 initiates a transition from the critical-on state 208 to a process-on state 210 in which the critical partition 112 is powered on and at least one process partition 114 is powered on 114, e.g., to enable processes and/or applications mapped to the at least one process partition 114 to be executed. In another example, the power gating circuit 104 initiates a transition from the critical-on state 208 to a base logic off state 222, as further discussed below with reference to block 310.

As part of independently controlling the power supplied to the one or more partitions, control signals are issued to power on the one or more partitions, and the control signals include six or more bits having programmed thereon a power up sequence of the one or more partitions through multiple wake states having different wake values and delays between successive wake states (block 306). By way of example, the power gating circuit 104 issues control signals instructing the power gating logic 120 to power on one or more partitions 112, 114. The control signals include six or more bits, e.g., fourteen bits in various examples. Programmed within the six or more bits are multiple wake states having different wake values, e.g., values of electrical current to be supplied to the partitions 112, 114 to be powered on. For example, each successive wake state is associated with a progressively higher wake value, e.g., to progressively ramp-up the current. Also programmed within the six or more bits are delay values between the wake states. The delay values are amounts of time (e.g., numbers of clock cycles) to wait before ramping up the current to a next successive wake state.

As part of independently controlling the power supplied to the one or more partitions, amounts of voltage supplied to the multiple partitions are independently controlled such that the voltage concurrently supplied to two or more partitions is different (block 308). By way of example, the power gating circuit 104 is configured to supply the regulated output voltage 212 or the bypass voltage 214 to any of the partitions 112, 114 that are powered on.

As part of independently controlling the power supplied to the one or more partitions, a transition is initiated to a power state in which an entirety of a base logic of the digital logic circuit is powered off (block 310). By way of example, the base logic of the digital logic circuit 106 represents the digital logic circuit 106 before being modified by external logic of the device 102 that is external to the digital logic circuit 106. Here, the power gating circuit 104 initiates a transition to the base logic off state 222 in which an entirety of the base logic of the digital logic circuit 106 is powered off. In the base logic off state 222, the only portion of the digital logic circuit 106 that is powered on is the power gating logic 120 inserted into each of the circuitry subsystems 118. Even the critical-on circuitry 116 of the digital logic circuit 106 is powered off in the base logic off state 222.

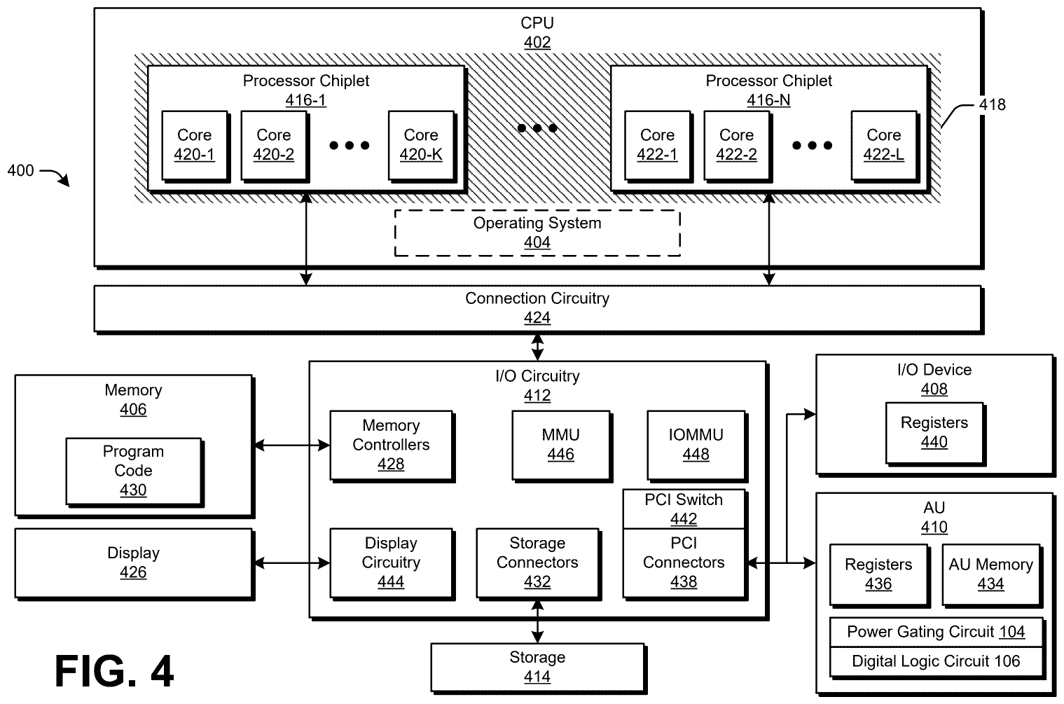

FIG. 4 is a block diagram of a processing system configured to execute one or more applications, in accordance with one or more implementations. FIG. 4 includes a processing system 400 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 400 includes a central processing unit (CPU) 402. In one or more implementations, the CPU 402 is configured to run an operating system (OS) 404 that manages the execution of applications. For example, the OS 404 is configured to schedule the execution of tasks (e.g., instructions) for applications, allocate portions of resources (e.g., system memory 406, CPU 402, input/output (I/O) device 408, accelerator unit (AU) 410, storage 414) for the execution of tasks for the applications, provide an interface to I/O devices (e.g., I/O device 408) for the applications, or any combination thereof.

In this example, the power gating circuit 104 and the digital logic circuit 106 are depicted in the AU 410. In variations, however, the power gating circuit 104 and the digital logic circuit 106 are included in and/or are implemented by one or more different components of the processing system 400, such as the CPU 402, the memory 406, the I/O device 408, the I/O circuitry 412, the storage 414, and so forth. In at least one implementation, the power gating circuit 104 and the digital logic circuit 106 or portions of the power gating circuit 104 and the digital logic circuit 106 are included in at least two of the depicted components of the processing system 400. By way of example, the power gating circuit 104 and/or the digital logic circuit 106 may be included in or otherwise implemented by at least the CPU 402 and/or the AU 410.

The CPU 402 includes one or more processor chiplets 416, which are communicatively coupled together by a data fabric 418 in one or more implementations. Each of the processor chiplets 416, for example, includes one or more processor cores 420, 422 configured to concurrently execute one or more series of instructions, also referred to herein as “threads,” for an application. Further, the data fabric 418 communicatively couples each processor chiplet 416-N of the CPU 402 such that each processor core (e.g., processor cores 420) of a first processor chiplet (e.g., 416-1) is communicatively coupled to each processor core (e.g., processor cores 422) of one or more other processor chiplets 416. Though the example embodiment presented in FIG. 4 shows a first processor chiplet (416-1) having three processor cores (420-1, 420-2, 420-K) representing a K number of processor cores 422 and a second processor chiplet (416-N) having three processor cores (e.g., 422-1, 422-2, 422-L) representing an L number of processor cores 422, in other implementations (L being an integer number greater than or equal to one), each processor chiplet 416 may have any number of processor cores 420, 422. For example, each processor chiplet 416 can have the same number of processor cores 420, 422 as one or more other processor chiplets 416, a different number of processor cores 420, 422 as one or more other processor chiplets 416, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

Additionally, within the processing system 400, the CPU 402 is communicatively coupled to an I/O circuitry 412 by a connection circuitry 424. For example, each processor chiplet 416 of the CPU 402 is communicatively coupled to the I/O circuitry 412 by the connection circuitry 424. The connection circuitry 424 includes, for example, one or more data fabrics, buses, buffers, queues, and the like. The I/O circuitry 412 is configured to facilitate communications between two or more components of the processing system 400 such as between the CPU 402, system memory 406, display 426, universal serial bus (USB) devices, peripheral component interconnect (PCI) devices (e.g., I/O device 408, AU 410), storage 414, and the like.

As an example, system memory 406 includes any combination of one or more volatile memories and/or one or more non-volatile memories, examples of which include dynamic random-access memory (DRAM), static random-access memory (SRAM), non-volatile RAM, and the like. To manage access to the system memory 406 by CPU 402, the I/O device 408, the AU 410, and/or any other components, the I/O circuitry 412 includes one or more memory controllers 428. These memory controllers 428, for example, include circuitry configured to manage and fulfill memory access requests issued from the CPU 402, the I/O device 408, the AU 410, or any combination thereof. Examples of such requests include read requests, write requests, fetch requests, pre-fetch requests, or any combination thereof. That is to say, these memory controllers 428 are configured to manage access to the data stored at one or more memory addresses within the system memory 406, such as by CPU 402, the I/O device 408, and/or the AU 410.

When an application is to be executed by processing system 400, the OS 404 running on the CPU 402 is configured to load at least a portion of program code 430 (e.g., an executable file) associated with the application from, for example, a storage 414 into system memory 406. This storage 414, for example, includes a non-volatile storage such as a flash memory, solid-state memory, hard disk, optical disc, or the like configured to store program code 430 for one or more applications.

To facilitate communication between the storage 414 and other components of processing system 400, the I/O circuitry 412 includes one or more storage connectors 432 (e.g., universal serial bus (USB) connectors, serial AT attachment (SATA) connectors, PCI Express (PCIe) connectors) configured to communicatively couple storage 414 to the I/O circuitry 412 such that I/O circuitry 412 is capable of routing signals to and from the storage 414 to one or more other components of the processing system 400.

In association with executing an application, in one or more scenarios, the CPU 402 is configured to issue one or more instructions (e.g., threads) to be executed for an application to the AU 410. The AU 410 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 410 includes one or more compute units that concurrently execute one or more threads of an application and store data resulting from the execution of these threads in AU memory 434. This AU memory 434, for example, includes any combination of one or more volatile memories and/or non-volatile memories, examples of which include caches, video RAM (VRAM), or the like. In one or more implementations, these compute units are also configured to execute these threads based on the data stored in one or more physical registers 436 of the AU 410.

To facilitate communication between the AU 410 and one or more other components of processing system 400, the I/O circuitry 412 includes or is otherwise connected to one or more connectors, such as PCI connectors 438 (e.g., PCIe connectors) each including circuitry configured to communicatively couple the AU 410 to the I/O circuitry such that the I/O circuitry 412 is capable of routing signals to and from the AU 410 to one or more other components of the processing system 400. Further, the PCIe connectors 438 are configured to communicatively couple the I/O device 408 to the I/O circuitry 412 such that the I/O circuitry 412 is capable of routing signals to and from the I/O device 408 to one or more other components of the processing system 400.

By way of example and not limitation, the I/O device 408 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 408 is configured to execute one or more operations, tasks, instructions, or any combination thereof based on one or more physical registers 440 of the I/O device 408. In one or more implementations, such physical registers 440 are configured to maintain data (e.g., operands, instructions, values, variables) indicating one or more operations, tasks, or instructions to be performed by the I/O device 408.

To manage communication between components of the processing system 400 (e.g., AU 410, I/O device 408) that are connected to PCI connectors 438, and one or more other components of the processing system 400, the I/O circuitry 412 includes PCI switch 442. The PCI switch 442, for example, includes circuitry configured to route packets to and from the components of the processing system 400 connected to the PCI connectors 438 as well as to the other components of the processing system 400. As an example, based on address data indicated in a packet received from a first component (e.g., CPU 402), the PCI switch 442 routes the packet to a corresponding component (e.g., AU 410) connected to the PCI connectors 438.

Based on the processing system 400 executing a graphics application, for instance, the CPU 402, the AU 410, or both are configured to execute one or more instructions (e.g., draw calls) such that a scene including one or more graphics objects is rendered. After rendering such a scene, the processing system 400 stores the scene in the storage 414, displays the scene on the display 426, or both. The display 426, for example, includes a cathode-ray tube (CRT) display, liquid crystal display (LCD), light emitting diode (LED) display, organic light emitting diode (OLED) display, or any combination thereof. To enable the processing system 400 to display a scene on the display 426, the I/O circuitry 412 includes display circuitry 444. The display circuitry 444, for example, includes high-definition multimedia interface (HDMI) connectors, DisplayPort connectors, digital visual interface (DVI) connectors, USB connectors, and the like, each including circuitry configured to communicatively couple the display 426 to the I/O circuitry 412. Additionally or alternatively, the display circuitry 444 includes circuitry configured to manage the display of one or more scenes on the display 426 such as display controllers, buffers, memory, or any combination thereof.

Further, the CPU 402, the AU 410, or both are configured to concurrently run one or more virtual machines (VMs), which are each configured to execute one or more corresponding applications. To manage communications between such VMs and the underlying resources of the processing system 400, such as any one or more components of processing system 400, including the CPU 402, the I/O device 408, the AU 410, and the system memory 406, the I/O circuitry 412 includes memory management unit (MMU) 446 and input-output memory management unit (IOMMU) 448. The MMU 446 includes, for example, circuitry configured to manage memory requests, such as from the CPU 402 to the system memory 406. For example, the MMU 446 is configured to handle memory requests issued from the CPU 402 and associated with a VM running on the CPU 402. These memory requests, for example, request access to read, write, fetch, or pre-fetch data residing at one or more virtual addresses (e.g., guest virtual addresses) each indicating one or more portions (e.g., physical memory addresses) of the system memory 406. Based on receiving a memory request from the CPU 402, the MMU 446 is configured to translate the virtual address indicated in the memory request to a physical address in the system memory 406 and to fulfill the request. The IOMMU 448 includes, for example, circuitry configured to manage memory requests (memory-mapped I/O (MMIO) requests) from the CPU 402 to the I/O device 408, the AU 410, or both, and to manage memory requests (direct memory access (DMA) requests) from the I/O device 408 or the AU 410 to the system memory 406. For example, to access the registers 440 of the I/O device 408, the registers 436 of the AU 410, and/or the AU memory 434, the CPU 402 issues one or more MMIO requests. Such MMIO requests each request access to read, write, fetch, or pre-fetch data residing at one or more virtual addresses (e.g., guest virtual addresses) which each represent at least a portion of the registers 440 of the I/O device 408, the registers 436 of the AU 410, or the AU memory 434, respectively. As another example, to access the system memory 406 without using the CPU 402, the I/O device 408, the AU 410, or both are configured to issue one or more DMA requests. Such DMA requests each request access to read, write, fetch, or pre-fetch data residing at one or more virtual addresses (e.g., device virtual addresses) which each represent at least a portion of the system memory 406. Based on receiving an MMIO request or DMA request, the IOMMU 448 is configured to translate the virtual address indicated in the MMIO or DMA request to a physical address and fulfill the request.

In variations, the processing system 400 can include any combination of the components depicted and described. For example, in at least one variation, the processing system 400 does not include one or more of the components depicted and described in relation to FIG. 4. Additionally or alternatively, in at least one variation, the processing system 400 includes additional and/or different components from those depicted. The processing system 400 is configurable in a variety of ways with different combinations of components in accordance with the described techniques.

What is claimed is:

1. A system comprising:
a digital logic circuit organized into multiple partitions, the digital logic circuit including base logic representing the digital logic circuit before being modified by external logic of the system that is external to the digital logic circuit; and
a power gating circuit to independently control power supplied to the multiple partitions of the digital logic circuit, and to initiate a power state transition for the digital logic circuit to a power state in which an entirety of the base logic of the digital logic circuit is powered off.

2. The system of claim 1, wherein the multiple partitions each include one or more circuitry subsystems, and the power gating circuit is configured to insert, into each circuitry subsystem of the multiple partitions, power gating logic enabling the power gating circuit to power on or off the circuitry subsystems.

3. The system of claim 2, wherein to independently control the power supplied to the multiple partitions, the power gating circuit is configured to issue control signals to the power gating logic of one or more partitions, the control signals causing the one or more circuitry subsystems of the one or more partitions to power on or off.

4. The system of claim 3, wherein the control signals to power on the one or more partitions include six or more bits having programmed thereon a power up sequence of the one or more partitions through multiple wake states having different wake values and delays between successive wake states.

5. The system of claim 3, wherein the control signals are delivered to the power gating logic of multiple circuitry subsystems of the one or more partitions via repeater circuits which cause arrival of the control signals at the power gating logic of the multiple circuitry subsystems concurrently.

6. The system of claim 3, wherein the power gating circuit includes multiple finite state machines assigned to corresponding partitions of the multiple partitions, and the power gating circuit is configured to:
receive a request to power on an individual partition of the multiple partitions; and
issue, by a finite state machine assigned to the individual partition, the control signals to the power gating logic of the individual partition in response to receipt of the request.

7. The system of claim 6, wherein the multiple partitions include at least one partition assigned to executing processes of the digital logic circuit, and at least one finite state machine assigned to the at least one partition is powered off when the at least one partition is powered off.

8. The system of claim 1, wherein to independently control the power supplied to the multiple partitions, the power gating circuit is configured to independently control amounts of voltage supplied to the multiple partitions of the digital logic circuit, the amounts of voltage concurrently supplied to at least two partitions of the multiple partitions being different.

9. The system of claim 1, wherein the multiple partitions include one or more partitions assigned to executing processes of the digital logic circuit and a critical partition including critical-on circuitry that is to be powered on to support execution of the processes, and the power gating circuit is configured to:
initiate, during an initial boot sequence for the digital logic circuit, a first power state transition for the digital logic circuit to a first additional power state in which the multiple partitions are powered on; and
initiate, responsive to a memory repair protocol having been completed by the digital logic circuit while in the first additional power state, a second power state transition for the digital logic circuit from the first additional power state to a second additional power state in which the critical partition is powered on and the one or more partitions are powered off.

10. The system of claim 9, wherein the power gating circuit is configured to initiate a third power state transition from the second additional power state to a third additional power state in which the critical partition is powered on and at least one partition of the one or more partitions is powered on to enable execution of one or more processes of the digital logic circuit assigned to be executed by the at least one partition.

11. The system of claim 9, wherein the power gating circuit is configured to:
initiate the power state transition from the second additional power state to the power state in response to a state of data within the digital logic circuit being saved to a non-volatile memory of the digital logic circuit or an external memory source that is powered on while the digital logic circuit is in the power state; and
initiate a fourth power state transition from the power state to the second additional power state, the fourth power state transition involving the state of data within the digital logic circuit being restored to a volatile memory source within the critical partition of the digital logic circuit.

12. The system of claim 1, wherein the power gating circuit is clock gated when the digital logic circuit is in the power state.

13. A device comprising:
a digital logic circuit organized into multiple partitions; and
a power gating circuit to independently control amounts of voltage supplied to the multiple partitions of the digital logic circuit, the voltage concurrently supplied to two or more partitions of the multiple partitions being different.

14. The device of claim 13, wherein the voltage supplied to an individual partition of the multiple partitions is different at different times.

15. The device of claim 13, wherein the power gating circuit is further configured to independently control power supplied to the multiple partitions by issuing control signals to the digital logic circuit causing one or more partitions to power on or off.

16. The device of claim 15, wherein the control signals to power on the one or more partitions include six or more bits having programmed thereon a power up sequence of the one or more partitions through multiple wake states having different wake values and delays between successive wake states.

17. The device of claim 13, wherein the digital logic circuit includes base logic representing the digital logic circuit before being modified by external logic of the device that is external to the digital logic circuit, and the power gating circuit is configured to initiate a power state transition for the digital logic circuit to a power state in which an entirety of the base logic of the digital logic circuit is powered off.

18. A method comprising:
receiving, by a power gating circuit, a request to power on one or more partitions of multiple partitions of a digital logic circuit; and
issuing, by the power gating circuit, control signals to power on the one or more partitions, the control signals including six or more bits having programmed thereon a power up sequence of the one or more partitions through multiple wake states having different wake values and delays between successive wake states.

19. The method of claim 18, further comprising independently controlling, by the power gating circuit, amounts of voltage supplied to the multiple partitions of the digital logic circuit, the amounts of voltage concurrently supplied to two or more partitions of the multiple partitions being different.

20. The method of claim 18, wherein the digital logic circuit and the power gating circuit are integrated in a system-on-a-chip, and the digital logic circuit includes base logic representing the digital logic circuit before being modified by external logic of the system-on-a-chip that is external to the digital logic circuit, the method further comprising initiating, by the power gating circuit, a power state transition for the digital logic circuit to a power state in which an entirety of the base logic of the digital logic circuit is powered off.
